(19) United States
(12) Patent Application Publication
(10) Pub. No.: US 2011/0289322 A1
(43) Pub. Date: Nov. 24, 2011

(54) PROTECTED USE OF IDENTITY IDENTIFIER OBJECTS

(76) Inventor: Mehran RASTI, Fredericksburg, VA (US)

(21) Appl. No.: 13/178,036

(22) Filed: Jul. 7, 2011

Related U.S. Application Data
(63) Continuation-in-part of application No. 11/957,266, filed on Dec. 14, 2007.

(51) Int. Cl. G06F 21/00; H04L 9/32

(52) U.S. Cl. 713/182

(57) ABSTRACT

This invention states that any and all physical and virtual objects meeting certain criteria may be used as Identity-Identifier-Objects to authenticate people, businesses, organizations, as well as other physical or virtual objects. While accomplishing said task, this invention discloses objects, methods, and special data structures to hide said Identity-Identifier-Objects from exposure to the public, while being used in their intended roles. Additionally, the objects and methods introduced use ownership property of virtual and physical objects to control access and to implement access and licensing rights of physical and virtual objects. Numerous applications areas such as allocation of digital rights, licensing, notarization of digital signatures, and controlled use of personal photographs, fingerprints and other biometric identifier-objects are also illustrated.

### CROSS REFERENCE TO RELATED APPLICATIONS

This application is a Continuation in Part of U.S. patent application Ser. No. 11/957,266 filed on Dec. 14, 2007 and claims the benefit of that application.

### BACKGROUND OF INVENTION

1. Field of Invention

The invention introduces different types of Identity-Identifier-Objects and presents methods for their confidential and protected use in day to day business and official settings. Some well-known Identity-Identifier-Objects, or Identifier-Objects for short, have been in use with little or no protection for years. Examples are Social Security Numbers, organizations' Federal Tax Id Numbers (EIN), Patient Numbers, Student Numbers, and so forth. As we are aware the insufficient protection efforts to date have failed to curb wide-spread instances of Identity-Theft and have caused incalculable amounts of financial loss, personal headaches, and waste of time and resources.

There can be three categories of Id-Identifier-Objects that include, “Fixed-for-Life of the object Id-Identifier-Objects”, “Semi-Fixed-Id-Identifier-Objects”, and “Variable-Id-Identifier-Objects”.

Methods presented in this document allow secure use of all said categories of Identifier-Objects to authenticate objects and entities to which they refer. The methods are applicable to all Id-Identifier-Objects that fall within the three Id-Identifier-Objects categories described above, allowing their full use, while preserving the confidentiality of the Original-Identifier-Objects.

### STATUS OF PRIOR ART

Attempts to keep Identity Identifier Objects such as peoples' Social Security Numbers, Patient Numbers, Student Numbers and the like, private throughout years, have failed. Legislations by the Congress, as well as many technical attempts in the past and present have not been, and are not effective. The clue is the ever increasing instances of Identity Theft as we witness today. In the information age and the age of inter-related data bases clustered online worldwide, and advanced data mining technologies no name, address, account number, or Social Security Number can remain a secrete indefinitely. Identifier-Objects such as Social Security Numbers and EINs are exposed, even with added precautions such as asking one's address and zip code, mother's maiden name, first pet's name and the like. Such so called secrete questions and answers have lost their secrecy and novelty through inter-connected data bases, data mining techniques, and data sharing amongst businesses and organizations.

Being concerned about Identity theft, on May 16, 2005 the Applicant filed application Ser. No. 11/129,827 and introduced appending one out of many Passwords that were dedicated to a group of businesses and merchants to a person's Social Security Number (SSN); therewith protecting peoples' SSN through concatenation and pairing of such dedicated passwords. Later on, the Applicant by the way of Application No. 60/710,693 introduced “Standard-Made-up Social Security Number (SMSSN)”. On Aug. 19, 2005 through application Ser. No. 11/506,476, the Applicant introduced Organization-Specific-Encryption-Algorithms to be assigned to organization-specific-Rule-Numbers and be used in encrypting a comingled combination of an Identity-Identifier with one or many of its pre-assigned Identity-Identifier-Passwords.

While the Applicant's prior art, as well those mentioned above are narrow in scope in dealing with the more commonly used Identity-Identifiers, through application Ser. No. 11/957,266 the Applicant has identified other types of fixed and semi-fixed Identifier-Objects. In the same Application, the Applicant extended the scope of Identity-Identifiers of the previous Applications, to encompass the other two classes of not-fixed-for-life Identity-Identifier-Objects, and Variable-Identity-Identifiers. In the same Application, the Applicant included Credit Bureaus to be the 4^{th} entity participant in the information flow loop, where applicable to different scenarios. In the same Application, the Applicant improved the sophistication and improved the security of the product by incorporating Identity-Identifier-Constant-Character-Strings to be an added data element into the comingled combination of an Identity-Identifier-Object with one or more of the Object's pre-assigned Identity-Identifier-Passwords and a User-specific-custom-made encryption process utilizing Rule-Number-Algorithms. See FIG. 2A.

### BRIEF SUMMARY OF THE INVENTION

### A. Purpose of the Invention

People and organizations of all sorts use Identifier-Objects and need to protect them from misuse. This invention specifies methods and data objects to use Identifier-Objects without exposing the original identifier-character-string to the public.

### B. Objects, and Entities Used

Objects are the people and organizations' identities to protect, and since peoples' and organizations' identities are represented by data strings, protecting said objects require keeping said data strings secure, while being put to use in everyday business. In addition to the objects, the invention utilizes four entities. Item 1, below, describes the objects, while items 2, 3, 4, and 5 specify the role and functions of the entities.

1. “Identifier-Objects” are physical or virtual objects that represent people, or organizations. They identify one of a person, an organization, a government agency, a business entity, a thing, or another physical or virtual object; including the right or privileges of use. Once an Identifier-Object has been uniquely registered to its owner with a trusted, it becomes an Identity-Identifier-Object. A collection of the sort is referred to as “Identity-Identifier-Objects” (Id-Identifier-Objects). Id-Identifier-Objects are represented by strings of number and character strings that are sometimes stored in binary files; examples of the latter type include a person's digitized fingerprint, photograph, or signature when stored in a file.

2. “User”, or a third party user, is an organization, a business, an institution, or a governmental agency and like entities, that frequently use Identity-Identifier-Objects in business, to register and authenticate the identity of their clients, and for other business purposes.

3. “Owner” is a person who owns an Identity-Identifier-Object. The concept of ownership in this document means “the right to use”. A good example is a Social Security Number that is owned by the U.S. Government, but is used by people. User entities of all sorts use Identity-Identifier-Objects for business purposes. At the same time, the Owner needs to prevent his/her Identity-Identifier away from exposure and falling in hands of strangers and in public domain.

4. “Trustee” is a private enterprise, a credit bureau, or a mandated governmental agency that is charged with the task of issuing and supporting unique Identity-Identifier-Objects, utilizing secure computer environments for continuous digital access and mechanisms to keep Identity-Identifier-Objects secure. In addition, Trustee organization is charged with the task of devising many different encryption algorithms such that each algorithm is dedicated for use by a specific business, groups of businesses, organizations, institutions, and agencies (Users).

5. “Credit Bureau” is an entity that has compiled extensive information on people and organizations of all types in its data bases. Personal and financial information on people are provided to “Users” at a cost and upon request.

### C. Process Flow Summary

The primary object to protect is a person “Owner”, or Owners in charge of an organization; hence, in order to protect the person, we must protect his/her personal and business Identity-Identifiers. To do so:

1. An “Owner” applies to open a “Personal Account” with Trustee. He/she provides all necessary documents, as required by Trustee to authenticate:
a) His/her true identity
b) That he/she is the “Owner” of the Id-Identifier-Object he/she is seeking to protect through registration with Trustee. See FIG. 1, Event Label 1, and FIG. 1A, Event Label 1.

2. Upon examination of the submitted application, authentication of the person applicant with ownership documents by Trustee, the person is hereafter called the “Owner” of the Id-Identifier-Object. Trustee will then issue and assign a Personal Account number, a logon-Id, and an account-access-password. See FIG. 1, Event Label 2, and FIG. 1A, Event Label 2. A person may register more than one Id-Identifier-Object in one personal account.

3. For each of Id-Identifier-Object an Owner is seeking to protect, after account approval, Trustee will generate:
a) One Proxy-Id-Identifier-Object
b) In cases an Owner is registering more than one Id-Identifier-Object to protect, a numeric index to each Id-Identifier-Object is also generated.
c) Many Proxy Id-identifier-Passwords.
d) A string of 8 or more characters from the extended ASCII, and extended UTF character sets. This data element is named “Id-Identifier-Object-Constant-Character-String.
Above items (a) and (b) are recorded in what is named X-File, and items (b), (c), and (d) are stored in Y-File. See FIG. 1 and FIG. 1A, Event Label 3. Also see FIG. 3-A for X & Y File formats.

4. The above data items may be recorded on a magnetic, optical, or memory card or device, or it may be uploaded to Owner's (hand-held) computer, a multi-function cell-phone-computing device, or to a personal computer. See FIG. 1, and FIG. 1A, Event Label 4. Trustee also designs and assigns a Rule-Number with associated Id-Identifier-Object-Constant-Character-Strings to each one of its required Users in user-specific Z-Files. See FIG. 3B.

5. Having access to the above four data items of (a) through (d) the Owner communicates to the User and obtains User's Rule-No. and hence the custom-made User-Encryption-Algorithm-Rule (out of User's Z-File). Comingling and encrypting together all data items shown in X and Y Files, the Owner generates an Encrypted-Identity-Identifier-Object (Pxy-Id). See FIGS. 2A, 2B, 2C, and 2D. The Owner will use any or more of his/her hand-held computer, personal computer, or User's computer to generate a User-specific-Encrypted-Id-Identity-identifier, depending on Owner's location and available computing equipment. See FIG. 1, Event Label 5.

In case of charge card processing, FIG. 1A, Event Label 5, the Owner submits the generated Pxy-Charge-Card-Number to merchant (User).

6. Owner will now transfer the custom-made Encrypted-Identity-Identifier-Object (Pxy-Id) to Trustee. See FIG. 1, Event Label 6.

In case of charge card processing, FIG. 1A, Event Label 6, after processing its sale, the Merchant submits the generated Pxy-Charge-Card-Number to Trustee.

7. Trustee's computer receives Owner's Encrypted-Identity-Identifier-Object (Pxy-Id), decrypts and decodes the transmitted Pxy-Id to its comprising data elements, according to FIG. 4A and obtains Owner's original Id-Identifier-Object from its Owner-Account-data base (db1), with User-Number (Merchant-No) and User-Name from its User-Account-data base (db2). At this juncture, Trustee transmits this information to Credit Bureau. See FIG. 1, Event Label 7.

In case of charge card processing, FIG. 1A, Event Label 7, the Trustee retrieves the Owner's Real-Charge-Card-Account-Number from its User-Account-data base and submits it to Charge-Processor entity.

8. Using Owner's Real-Id-Identifier-Object and name, Credit Bureau retrieves Owner's requested information, and transmits it to requesting User (in accordance to its contract with User), having access to its predisposed User/Merchant-Number and User's name. See FIG. 1, Event Label 8.

In case of charge card processing, FIG. 1A, Event Label 8, the Charge-Processor entity processes the charge transaction and credits/debits the merchant (User) account accordingly.

### BRIEF DESCRIPTION OF THE SEVERAL VIEWS OF THE DRAWINGS

FIG. 1: “Overall process flow of Proxy and Pxy Identity-Identity-Identifier-Objects to shield the Real Identity-Identifier-Object”. The diagram shows the entire basic process and relationship of objects and entities that are used. Depending on the type of Identity-Identity-Identifier-Object we are processing, minor variations in this general diagram are expected. FIG. 1A is such an example.

FIG. 1A: “Charging a purchase with Pxy Charge Card Numbers that change with every merchant”. The type of Identity-Identifier-Object in this flow diagram is a Credit or Debit Card number. In this process flow a charge processing entity replaces the Credit Bureau entity of the FIG. 1.

FIG. 2A: “Basic understanding of objects necessary to make Encrypted-Id-Identifier-Objects”. This is a schematic showing the 4 data elements that combine and jumble together. The 4^{th} data element is an Encryption-Algorithm-Rule that is designed differently for every User of an Id-Identifier-Object.

FIG. 2B: “Process flow diagram and objects used in making Encrypted-Id-Identifier-Objects (Pxy-Id) on User's machine and its transmission to Trustee”. This procedure is usually used when an Owner is present at User's site, and can retrieve User-Encryption-Algorithm-Rules out of User's computer terminal and can perform bulk of the encryption process on the User's CPU. Other necessary data elements still come from Owner's hand-held device and/or (plug-in) memory.

FIG. 2C: “Process flow diagram and objects used in making Encrypted-Id-Identifier-Objects (Pxy-Id) on (hand-held) computer and its transmission to Trustee”. This schematic diagram shows how Encrypted-Id-Identifier-Objects (Pxy-Id) are generated on Owner's hand-held computer or on a home PC. This method is used in long-distance and over-the-phone Id authentication and when Owner does not have access to User's computer peripheral/station.

FIG. 2D: “An illustration showing comingling of X, Y, and Z-File data contents producing an encrypted (Pxy) Id-Identifier-Object”. This is just an illustrative example of thousands of programmatic code variations that are possible.

FIG. 3A: “Representative diagram showing X-File &Y-File data fields and structure”. These files reside in removable memory module for plug in into the computer that generates Encrypted (Pxy) Id-Identifier-Objects, or are built in the device that is distributed by Trustee.

FIG. 3B: “Representative diagram showing Z-File structure and data fields. This file resides in User computer & at Trustee's data base.” Rule data out of this file is used to generate Encrypted (Pxy) Id-Identifier-Objects”.

FIG. 3C: “View of a simpler process to form Encrypted-Identifier-Objects (Pxy-Id) by using one of Owner's Id-Identifiers with Rule-No. This diagram is a simplified combination of the data elements of FIGS. 3A, and 3B.

FIG. 4A: “Trustee's decryption of received Encrypted-Id-Identifier-Object (f) and extraction of data items (h), (i), (j), and (k).” This allows Trustee to on extracted data to Credit Bureau for the look-up and retrieval of requesting Owner information to User.

FIG. 4B: “Trustee's decryption of received Encrypted-Id-Identifier-Object (Pxy-Id) into its comprising objects.” This diagram shows the reverse process of FIG. 3C, and is to be used in simpler processes, such as processing a credit or a debit card account.

FIG. 5: “A sample Pxy-Id”. This diagram shows a sample representation of an Owner's Encrypted-Id-Identifier-Object, or “Pxy-Id” for short.

### DETAILED DESCRIPTION OF THE INVENTION

### A. Objects

Following is an introduction to “objects” of the invention that are the objects of the methods described in this document. Section B, below explains other objects and “entities” and their role in the execution of the methods introduced.

The first type of an object is a person with an Identity-Identifier we intend to protect from being taken advantage of through misuse of one of his/her Identity-Identifier-Objects. Examples of Identity-Identifier-Objects are: Social Security Number, electronic signature, digitized form of fingerprints, the digital form of photographs, digital art work (software, music, video, graphic arts, etc.), or a licensed software.

A second type of an object is a business, an organization, or an institution of sorts we are trying to protect from misuse of their Identity-Identifier; those usually being Federal Tax Id Number (EIN), and business property such as company owned property, licensed software, right to enter certain premise, or privilege of using certain services, employee-only facilities, and the like.

In the mentioned example objects above, it is useful to note that, even though the person and organization are objects themselves, they are also “object owners”. Every object to which some value is attached is worthy of protection. The reason is obvious, because stealing, misuse, or unauthorized use of objects cause loss, affects and harms people and organization owners, or exposes object owners to liabilities and law suits. Example being misuse of a credit card number, or unauthorized use of company owned software. Aforementioned objects have been considered as Identity-Identifier-Objects, since their privilege of use is dependent on ownership by a person-owner, or an organization/business owner.

This invention shows:
a) Methodologies and data structures to protect the exposure and misuse of confidential Identity-Objects that are used in everyday business, and;
b) That any Identity-Identifier-Object of any type, once registered with a Trustee, can be used to “authenticate” the identity of its owner; “Owner” implies the person or the entity who “Owns” the object or the right to use or benefit from it in some fashion.

Supposing the ownership of a computer is officially registered under its serial number to its owner-person. Under this situation, it is entirely possible to authenticate said person's identity through the computer's serial number; the additional requirement being that such a serial number must be unique. So, one may wonder why every business is just hooked on using peoples' Social Security Numbers for identity authentication purposes? Casing point made here is the fact that all registered objects having been assigned unique Identifier-Object-Character-Strings or bar codes of sorts, can be utilized as Identity-Identifier-Objects. The following definition is hence in order:

An “Identity-Identifier-Object” is an object that identifies a person, a business/organization, a thing, or another physical or virtual object; including the right or privileges of using said object.

### B. Entities

The four entities, although objects by definition, that are used in this document are, “Owner”, “User”, “Trustee”, and “Credit Bureau”; a description of each follows:

“Owner” is a person who owns an Identity-Identifier-Object or those people who have officially been delegated to safeguard the use of an organization's Identity-Identifier-Objects and acting in the capacity of an “Owner”. Such an Owner must have the mandate and be authorized to protect the organization's Identity-Identifier-Object; to keep it safe and protect the “object” from being misused or to fall into the wrong hands. In this document the concept of ownership also implies “the right to use” and enjoy the benefits of object(s) owned. A good example of an owner is a Social Security Number which is owned by the U.S. Government, but is used by the person to whom the SSN is assigned.

“User” is an organization, business, a hospital, a school, a governmental agency and the like, that frequently uses Identity-Identifier-Objects in business, to authenticate the identity of their clients, and/or to obtain financial and background information on their clients for business purposes. Users use Identity-Identifiers to check their clients' credit score, credit history, work history, and other details. A bank (User) might need to check the credit history of a business and its net worth. Object owners are therefore clients of Users.

“Trustee” is an organization, an enterprise, a credit bureau, or a mandated governmental agency that is charged with the task of issuing, supporting, and safeguarding all or a few types of Identity-Identifier-Objects. Trustees must utilize state of the art, computer equipment and networks and environments equipped with secure digital access and processing mechanisms to keep Identity-Identifier-Objects and data components secure and available at all times. Additionally, a Trustee organization is charged with the task of devising and designing many different User-specific encryption algorithms (User-Encryption-Algorithm-Rules) such that each User algorithm would yield a different character string or binary file output when the same data stream is input. See section F for detail description of Trustee roles and functions.

“Credit Bureau” is an entity that collects, compiles, and sells information on people, companies, and “Users”. Credit Bureaus are in contractual agreement with Users for the type and range of services they render and the fees they charge. Compiled personal and financial information on people are at the least indexed on individuals' Social Security Numbers and are augmented by client name, address, and other commonly referenced data items. Information on large, small, and incorporated businesses as well as registered organizations are also included and are at the least indexed on their EINs (Federal Tax Id Numbers). “Users” have signed contractual agreements with one or more Credit Bureaus to receive business related information they need on their clients.

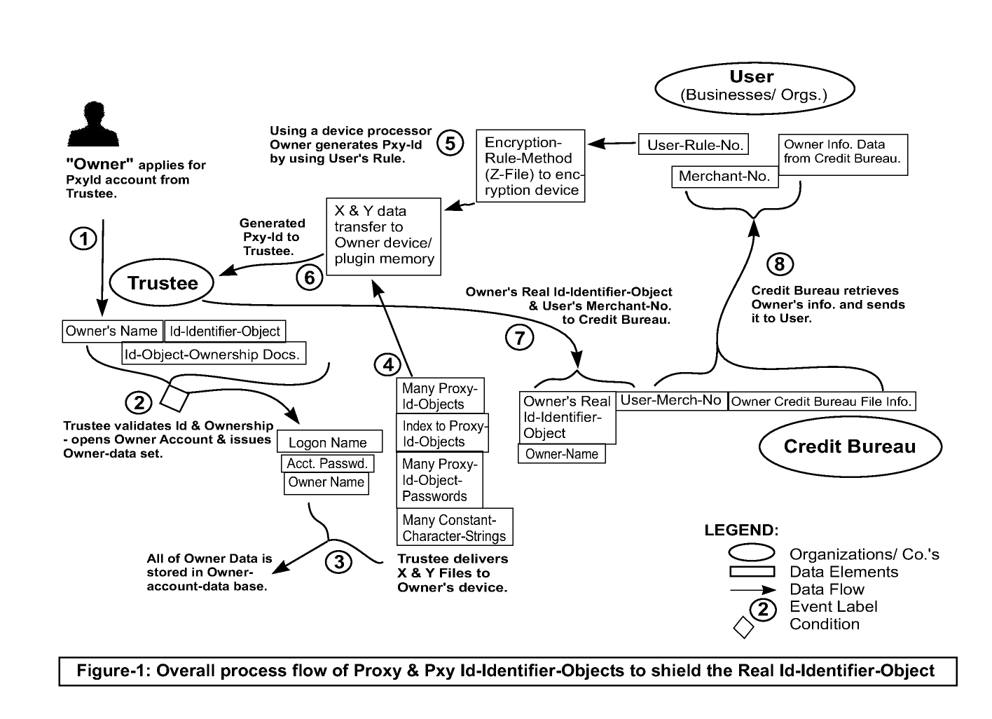

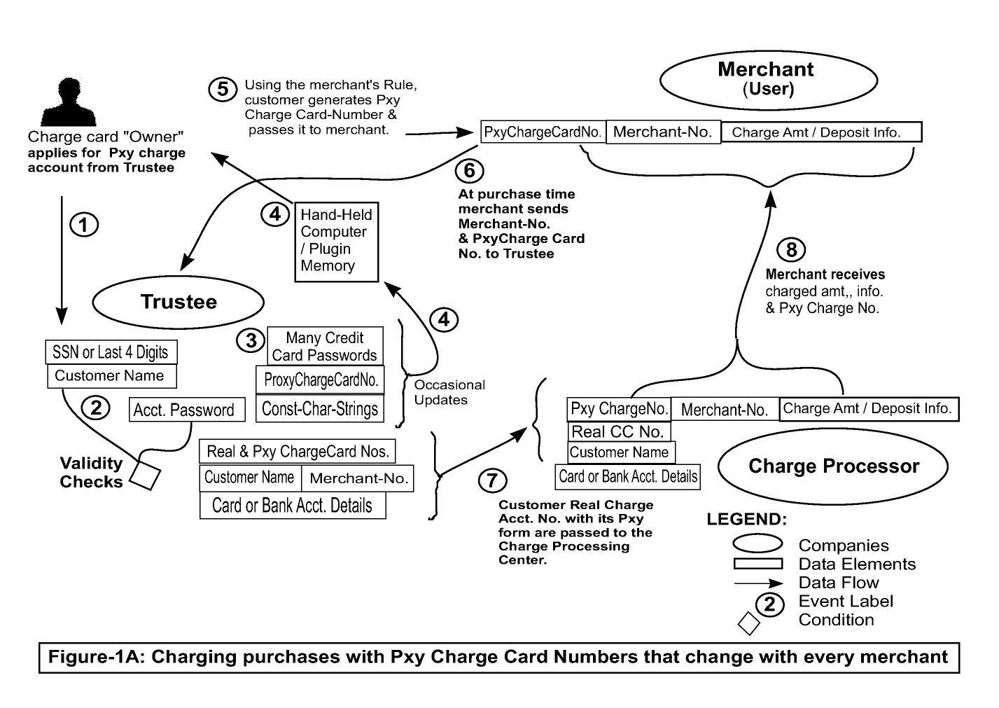

See FIG. 1 for the inter-relationship of the above mentioned entities, and information flow among them. There can be other types of non-obvious entities replacing one of the above. For example, in case of a charge card as an Identity-Identifier-Object, this entity would be a “charge processing” entity, or a bank. See FIG. 1A. In case of a door entrance code, credit bureau's role would be replaced by a computerized system that processes and authenticates a person's right to enter. Numerous other scenarios also exist that are outside the scopes of this document.

### C. Purpose of the Invention

A person's, an organization's, or other object's Identity-Identifiers are assigned a string of numbers and characters, and in some instances an entire binary computer file. In order to protect the owner, we must protect the Identity-Identifier-Objects' data representation that a person or an entity owns and uses. The invention presents methods through which Identity-Identifier-Objects are “masked” in a way that each User receives a different instance of the masked Identity-Identifier-Object they work with. The invention refers to such “masked” identity identifiers as Encrypted-Identity-Identifier-Objects, or Pxy-Id for short. Pxy-Ids are encrypted instances of some proxy or dummy substitutes of real (raw) identity identifier counterparts they originate from (their original values). Same Owner's Pxy-Id would have a different string or file representation (face) for different Users. As an example, a person with the social of “562-178-9110” would be handled in the “X-Bank” with the Pxy (face/substitution) value of “P26508Q01” while the same person would have a substitution PxySsn of “P01N87326” in the “Y-Bank”.

By using Proxy and Pxy Identity-Identifier-Objects users of Identity-Identifier-Objects would still be able to obtain credit and historical information on a person or an institution, without sacrificing functionality and security. The Original Identity-Identifier-Objects remain safe and hidden from the eyes of User-organizations' employees, and employees of other organizations who have data sharing agreements with source organizations.

When a person's identity Identity-Identifier-Object changes, that person will no longer be track-able through his/her old (original) identity-identifier on record; and given time, references to person's recorded information become obsolete and instances of Identity Theft will vanish.

This invention expands on the definition of an Identity-Identifier to encompass a much broader utilization of Identity-Identifier-Objects, where any Trustee registered object that an owner owns, be it physical or virtual, becomes an object to use in authenticating its owner.

### D. Identifiers and Identifier Types

Recalling the definition of Identity-Identifier-Objects: Identifier-Objects are objects that represent people, organizations, or other objects. They identify one of a person, an organization, a government agency, a business entity, a thing, a service, right or privilege, and as applicable to physical and virtual objects. Once one said object having a unique Identifier-Object has been properly registered to its Owner with a Trustee, it can be utilized as an Identity-Identifier-Object. A collection of the sort is referred to as “Identity-Identifier-Objects” (Id-Identifier-Objects). Id-Identifier-Objects are represented by strings of numbers and characters strings that are stored as characters, and in binary files; examples of this type include a person's digitized signature, digitized fingerprint, and digitized photograph in their encrypted form, as are explained in the following sections.

Identity-Identifier-Objects can be classified in three ways; those that attach to a person, entity, or another object for the life of that object, person, or entity without change. We refer to this class as “Fixed-for-Life Id-Identifier-Objects”, implying that they are fixed throughout the life of the object.

The second class of Identifier-Objects may change in their digital, string, or file (“face”) representations, while the person, entity, or the object they reference remains the same. We have named this class as “Semi-Fixed-Id-Identifier-Objects”. A examples is a credit card number; while a card's account holder bank and owner remain the same, the account, card number, or both may change. Another example is a “door access code”. The premise of entry stays the same, the access policies stay the same, but for maintaining security and accountability the door code (Identifier-Object) should be allowed to change for different people and different access privileges at different occasions. Software access key is another example of the same class of Identifier-Objects.

A third class of Identity-Identifier-Objects, which is referred to as “Variable-Id-Identifier-Objects” have a slightly different attribute; the Identifier-Objects' digital and/or the binary file content changes to some degree, but the Owner it references stays the same. This invention utilizes registration in that the registered instance of an Identifier-Object (with Trustee) becomes the basis for referencing its Owner's identity. Owner being a fixed person, entity, or another object “for-the-life-of-the-object” type of an identifier. A good example of this class is a person's signature in its digitized representation. Since a person never moves the pen in the same exact path in every signature, each of a person's digital signature when in digitized binary files, would contain different digital content. Other examples are a person's digitized finger-print, since the ink impressions are slightly different every time a person gets finger-printed. Digital strings of a digitally converted fingerprint, when recorded for recurring use present very similar processing anomalies as digital signatures. Please refer to the section on Processing Digital Signatures and Fingerprints. Another example of this class of Identity-Identifier-Objects is a person's photograph in its digitized form exhibiting similar digital recognition problems. While a human can easily decipher subtle differences in like photographs, signatures, and fingerprint patterns, a computer cannot always yield a consistently acceptable result, no matter how sophisticated of a recognition-software is used.

In this specification we refer to all “Identifier-Objects” that relate to Identity, collectively or in sole, as “Identity-Identifier-Objects”, “Id-Identifier-Object(s)”, “Identifier-Object(s)”, “Id-Objects”, or simply as “identifiers”. These words are used interchangeably in order to make the reading smoother, but they are meant to be interpreted all, as “Identity-Identifier-Object(s)”. Likewise, words like “User-Rule-Number”, or “User-Rule-No.”, “Rule-Number”, “Rule-No.”, and “Rule” are to be interpreted the same, and to mean the same.

The invention introduces and applies some new prefixes to already familiar Identity-Identifier-Objects. The prefixes are named “Proxy”, “proxy”, and “Pxy”. Proxy Identifier-Objects are changeable, substitutions of Id-Identifier-Objects that point to and function in place of their original counterpart Identity-Identifiers.

Proxy and Pxy Identifier are “dummy”, substitution character strings made-up by a Trustee to be utilized in place of, and in reference to an Owner's “original”, or “raw” Identity-Identifier-Object in order to keep original Id-Identifier-Objects confidential and secure. Proxy identifiers can also become exposed and misused over time. This is why we do not stop here. By the way of our previous patent application, we have and are introducing Pxy identifiers that are encrypted versions of their Proxy counterparts and change for every User automatically upon use.

Please note that Pxy Identifiers are an instance of their Proxy counterparts, but still are considered to be in class of Proxy Identifiers.

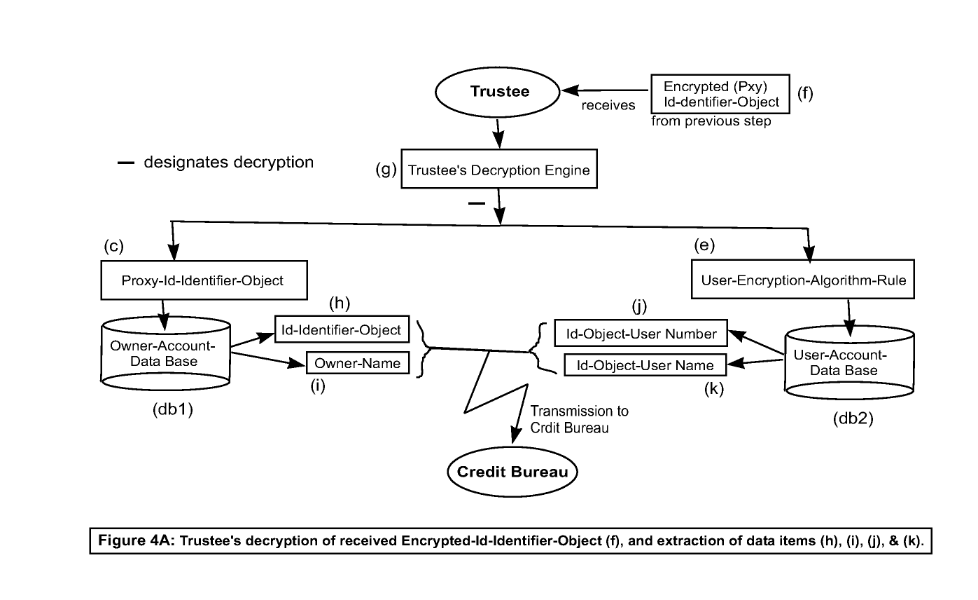

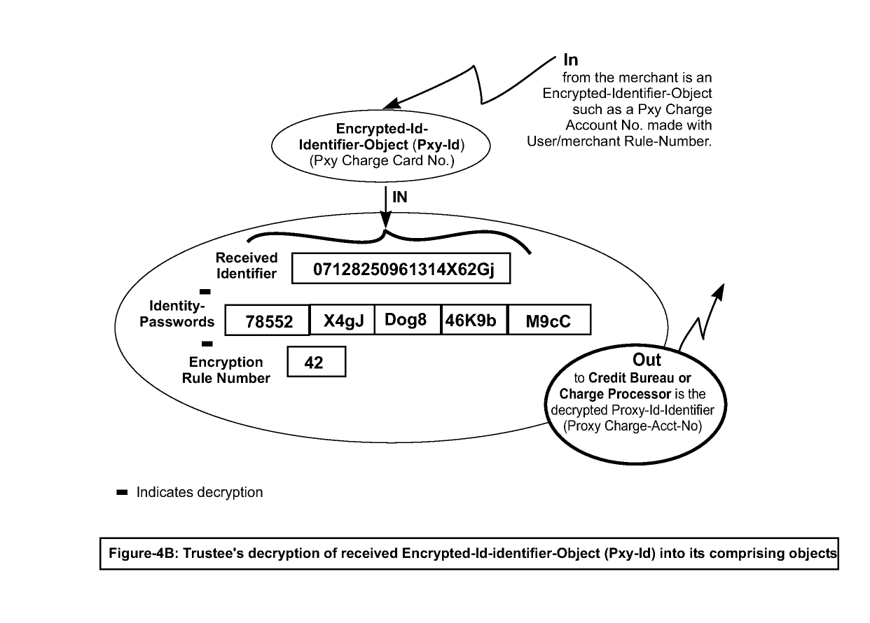

Prefixes of Proxy and Pxy, when added in front of an Id-Identifier-Object indicate the identifier's parent or genre. For example a ProxySSN refers to a substitution alphanumeric character string that points to someone's SSN and works in its place. A proxy EIN is in a similar way points to, and works as a substitute for an organization's EIN. So is a Proxy-Fingerprint, a Proxy-Photograph, and so on. In a similar fashion, a Pxy prefix to an Id-Identifier-Object's name establishes the type and the origination to the parent of the Id-Identifier-Object it references and points to. The difference between Proxy and Pxy types is that Pxy prefix is used to indicate and reference a “specially-encrypted” form of a Proxy-Identity-Identifier-Object. In this document, a Pxy identifier points to and reference a “specially-encrypted” instance of an original (raw) value of an Identity-Identifier-Object. Therefore, when decrypted, using the same user Rule-No., and reversed (decryption) algorithms, a Pxy Identifier should yield its related Proxy identifier and eventually, the Original Identifier Objects it originated from. For example, a PxySsn, when decrypted should yield back the ProxySSN and the related original SSN. See FIG. 4A and FIG. 4B.

Proxy and Pxy types have been designed to safeguard the confidentiality of Owners' Identity-Identifier-Objects, and to be “changeable” instances of their “parent” identifiers through use by their institutional Users. By using the introduced methods and illustrated techniques of this document, Pxy-Id values remain the same within a given business or institution, but different for other businesses; this way, the business purpose is maintained, while at the same time an Owner's risk of exposing his/her/its Id-Identifier-Object(s) to the public is minimized.

### E. The Ownership Concept

Within the scope of this invention and the applications of its methods, the Owner of an Identifier-Object is defined to be the person who owns an Identifier-Object, or the right to use it and benefit from it. One or more people of authority who have duly been designated as registered agents of a business, private or governmental agency or other types of functional entities are also considered to be “Owners”. To be considered Owner of a registered Identifier-Object with Trustee, a person must present to Trustee more than one official document in proving:
a) The identity of the person claiming Ownership to the Identifier-Object being registered; and,
b) Said person Owner must present official document(s) to a Trustee authenticating the actual Ownership of the Identifier-Object that is being registered.

An object, real or virtual is qualified to be registerable with Trustee as an Identity-Identifier-Object, as long as it meets both of the following conditions. The object:
1) Must possess uniquely identifiable virtual or physical boundary;
2) Must either already have a unique identifiable Serial Number or other unique tags, or must be uniquely tag able.

Examples of Identity-Identifier-Objects are a TV set with its own unique serial number, an IP packet with a registered detectable token, an organization or business entity with its own unique EIN, a person represented by his/her unique Social Security Number, an instance of a person's picture, signature, or fingerprint, a software with a unique usage key, a patient number in a hospital that needs to be referenced uniquely, and so on.

An object when it has been registered with a Trustee, has three useful utility properties:
1) The object has some associated worth, right, permission, and/or privilege associated with its use;
2) The object can be traced to its Owner through the Trustee; and
3) The Owner can be authenticated through utilizing owner's and ownership credentials existing with a Trustee.

This invention—presents methodologies for protected use of the 3^{rd} property above in that a registered instance of the Identifier-Object with a Trustee becomes the basis for authenticating the Identifier's Owner.

### F. Trustee; its Roles and Functions

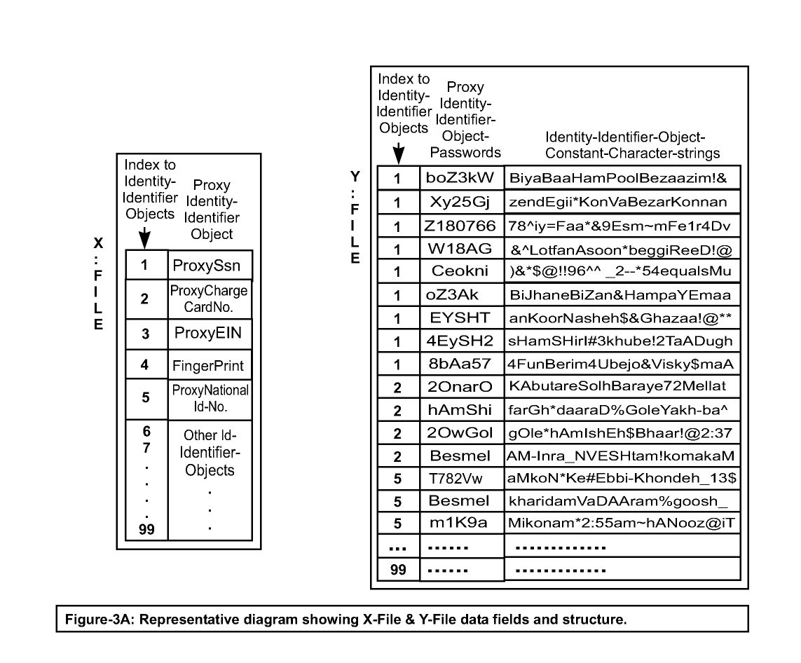

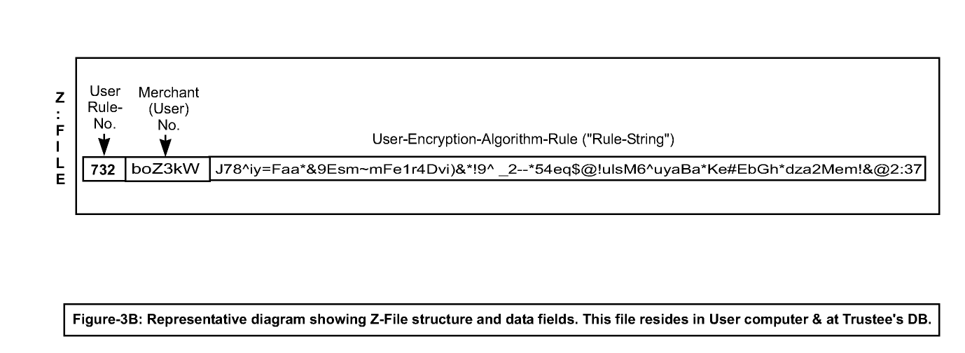

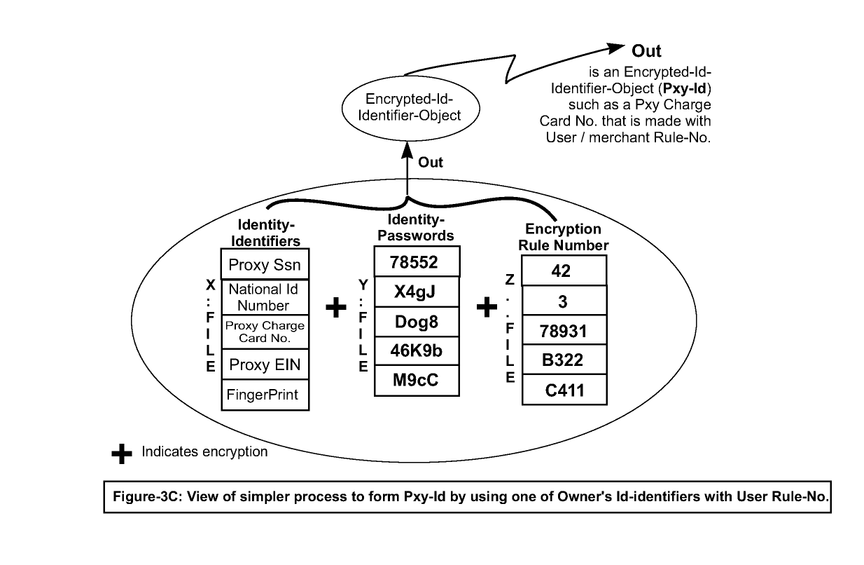

Trustee is a private enterprise, a credit bureau, or a mandated governmental agency that issues, registers, handles, maintains, and supports identity-Identifier-Objects and its related data components. Following is an itemized list of Trustee duties:
1) Trustee solicits the public and encourages people to take steps to protect the usage and security of their Identity-Identifier-Objects by applying for, and opening “Owner Accounts” for this purpose. See section Q, for registration process details.
2) After authentication of the identity of each applicant and verification and authentication of all presented documents pertaining to the ownership to the object the applicant is registering, Trustee will open an Owner Account and will issue a login User name and an Access Password. As with any other computer account, the account Owner may change his/her login credentials later on, and as he/she likes.
3) Trustee also registers one or multiple Identity-Identifier-Objects under the same Owner account; multiple, in cases when a person has more than one Identity-Identifier-Object to register.
4) Trustee issues unique Object-Identifier numbers or code for those objects that do not have their own unique tag, token, serial number, installation key, and the like, to function as a Proxy-Identity-Identifier-Object.
5) For each Owner Account, Trustee will store said owner's entire information in Owner-Account-data base.
6) For each and every registered Identity-Identifier-Object, Trustee issues all specified data objects as depicted in X-File fields (see FIG. 3A) and in Y-File data fields. X-File and Y-File data collection is called owner-data set (see FIG. 3A).
7) Trustee makes and supports its own custom-made hardware devices, including but not limited to optical, intelligent and dumb cards, data cartridges, RFID devices, variety of hand-held computer-telephone combined devices, such as hardware and software for Android devices and “Apps” for i-phone, and i-pad like devices. In addition, Trustee specifies the specs for its supported hardware, and custom made applications (Apps) for said devices. It also oversees their functionality, testing, and certification in addition to its maintenance, distribution, and sales.
8) Trustee records Owner X-File and Y-File data sets and encryption programs in variety of removable memory for plug in to Owners' hand-held devices and personal computers. Trustee also designs and programs Owner encryption and User decryption program code. Trustee stores owner-data set along with said encryption programs in Owner-member-file and delivers said Owner-member-file to the Owner via secure means. In some cases said programs and X and Y Files data are shipped together on the same memory module stored in Owner-member-file, while in other cases only owner-data set may be shipped or transferred to the Owner. For certain applications such as credit cards, Trustee records said content on optical, magnetic, RFID, or smart cards. In most cases, Trustee ships said firmware and/or devices to Owner via secure mail. In some cases Trustee may make said content available for secure download.
9) Trustee makes hardware and software available for authenticated downloading of its supported Owner X-File, and Y-File data updates as well as its pre-programmed encryption applications (Apps), only when it deems it to be secure and feasible for distribution to its account holders. This is done at Trustee's sole digression.
10) Trustee stores all of Owner's personal and login information, together with Owner-member-file in Owner-member-data base.
11) Trustee encourages businesses of all sorts, financial institutions, private, public, and governmental organizations, educational institutions, health care providers, insurance industry, state, and Federal agencies to apply and open “User-Accounts”, as well as “Business-Accounts”. This is to protect themselves and their clients against identity theft as well as their other business clients, private, and public against losses stemming from fraud. See section Q for registration details. Owner-Accounts are used both for people and Users to protect their respective Identity-Identifier-Object assets.
12) Trustee opens User-Accounts for User-Organizations and businesses that obtain data from Credit Bureaus for their business purposes. Said User-Accounts are linked to Owners of Identity-Identifiers. Accounts are opened after authentication of the identity of each of the registering User-Organization, its incorporation papers, in addition to verification and authentication of identity and credentials of each of the applicant's registering agents. Trustee will then open a User Account and issue a login User name and an Access Password. All said documents' data are also stored in User-Account-data base. As with any other computer account, the User-Account Owner may change its login password and other login credentials later on and as they please. Through User accounts, businesses and organizations are able to provide better and safer service to their clients and to mitigate business loss and law-suits stemming from Identity Theft of their clients and resulting fraud.
13) For every User-Account, Trustee designs and codes one or more User-specific “User-Encryption-Algorithm-Rules” (Rules).
14) Trustee designs all needed encryption and decryption algorithms, algorithm keys, associated data strings, processing programs and “Apps” for distribution and sale to Users. Trustee stores user processing-application-programs along with User's Z-File data in what is called User-member-file. Depending on User operating hardware and software environment, User's Z-File is shipped to the User with or without the applicable processing program code. Stored data in User-member-files are in most cases hard-coded in fixed memory and is factory fabricated inside User peripheral hardware that a Trustee supports.
15) Trustee User-Account-holders obtain pre-recorded User-Encryption-Algorithm-Rules, its supported proprietary computer devices, EPROM modules, and other trustee-offered digital devices, readers, and scanners solely from Trustee.
16) Trustee stores User-Account information together with User-member-files in User-Account-data base.
17) If a registered User-Organization needs to register its own Identity-Identifier-Objects such as its EIN, company credit cards, or other object or property of its own, then such ownership documents and proof also need to be examined, authenticated and accepted by Trustee. In this case, too, each of the registered Identifier-Objects under the same User-Account shall receive its own Identifier-Object processing X-File and Y-File data elements. See FIG. 3A.
18) Trustee provides sufficient facilities, computer equipment, software, telecommunication facilities, required procedures, and necessary access rights, and establishes security policies and procedures so it can provide around-the-clock secure service to all of its account holders; Owners and Users, both.
19) Trustee is responsible for issuing, safekeeping, maintaining, designing, managing, and supporting any and all types of physical and virtual Identity-Identifier-Objects it has decided to offer.
20) Trustee is responsible for its secure computer network availability and security both, internally on Intranet and LAN, and also through the Internet, and external voice and data transmission protocols, so that its authenticated Owners and Business Account holders with trustee-supported software and hardware may be able to securely connect to its computer system network and public-access data bases. In doing so, Trustee system administrators and security experts will set proper user access rights and permissions to create an efficient user-friendly, but secure computer networks.
21) Trustee may work with and delegate the design and manufacturing of its supported equipment, hardware, software and program code to some external contractors based upon their security guarantees, background knowledge and capability, reliability, and reputation, at its sole decision.
22) A partial role of the Trustee may be assigned to one or more license holder charge card processors, credit bureaus and other entities to function as independent or joint operators in order to carry out the functions as may become necessary under methods and procedures that are specified in his document.
23) Trustee will set its own “service fees” and fee schedule necessary for all of the itemized services it provides to all of its account holders. Such fees may be application fees, membership fees, annual fees, and per-transaction fees, both for Owners, and Users.

### G. Basic Methods and Architecture

Methods for making and using secure Identity-Identifier-Objects and related data constructs are presented below. First, we are going to describe FIG. 1 in a step-by-step approach and expand on specific details when it becomes necessary. FIG. 1 shows the entire basic process and relationship of objects and entities that are used. An explanation of drawings follows:

In step 1, a person Owner applies to open an Owner-Account with Trustee. Refer to Section F, item numbers 1-10 for a suggested list of task items that Trustee must do for its Owner-Account-holders. Also, see section Q of this document for suggested procedures in opening Owner and User accounts.

In step 2, applicants' Identity is authenticated by the Trustee, Ownership documents and proofs to the ownership of Objects that are being registered are also authenticated by the Trustee. If all authentications are satisfied, the Trustee proceeds with the next step in Owner's registration process.

In step 2 of FIGS. 1 and 1A, Owner-Account login User-Name, Account-Access-Password, and other login credentials are issued. Additionally, for every Id-Identifier-Object being registered, Trustee issues one Proxy-Id-Identifiers, with many Id-Identifier-Object-Passwords, and many Id-Identifiers-Constant-Character string sets. When more than one Id-Identifier-Object is registered, Trustee would generate numeric indices that point to each of Owners' registered Proxy-Id-Identifier-Objects and its related data fields as depicted in FIG. 3A. The data fields as shown in FIG. 3A are called Owner-Id-Identifier data fields. In one embodiment of the invention a single set of Owner-Id-identifier data fields are optically burned, bar-coded, or magnetically recorded on a card, or saved in an intelligent card's memory for applicable applications such as a Pxy-Charge-Card, where limited recording memory is needed. More often, Owner-Id-identifier data fields are stored in two Owner files named X-File and Y-File; a collection of which is referred to as “Owner-data set”. See FIG. 3A. The two files are usually stored in removable/plug-in memory modules that are mailed to registering Owners at the completion of the registration process.

In step 3, Owner-data set, along with entire Owner information, such as name, login information, passwords, and other relevant data items are also indexed and recorded in Trustee's own electronic files and in Trustee's Owner-member-data base, and are referenced to its registered Owner.

In step 4, the media (plug-in/removable memory) containing the registered Owner-Id-Identifier data sets of X-File and Y-Files are sent to the Owner via secure mail, or alternately, are made available for Owner's secure downloading to his/her device, depending on the owner's available hardware and requirements. At Trustee's sole digression, related application programs or Apps to process the required data sets may be stored in a Trustee approved device, plug-in memory, or embedded in hardware and sent to said Owner. Processor application programs and Apps may also be offered through secure links on the Internet, and/or provided through telephone transmission protocols for member downloading and updating, when deemed proper by Trustee.

A User who requests a client's (Owner) information from Trustee must have opened a User-Account with the Trustee. See section F, item numbers 11-17. Registered Users pay to authenticate the identity of a client-Owner and to perform credit check on their client as well as other Credit Bureau services for business purposes, and other official use.

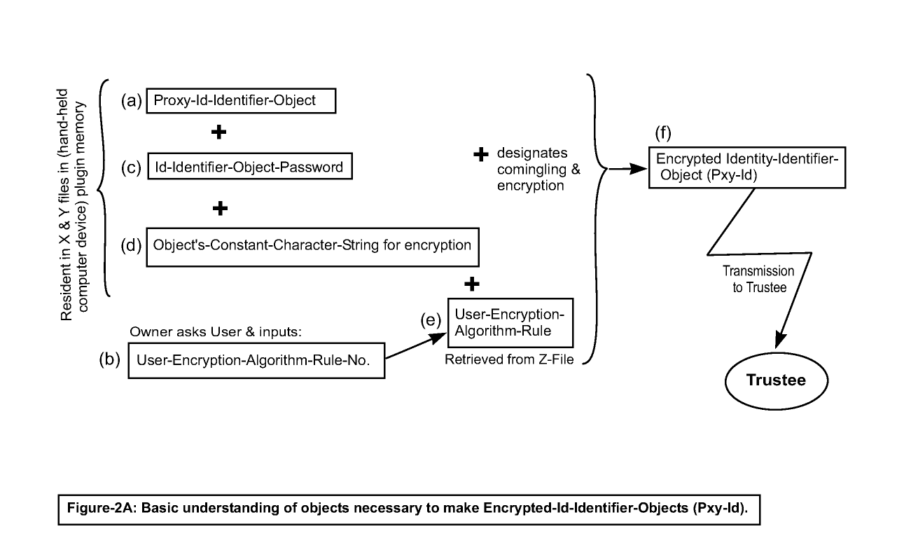

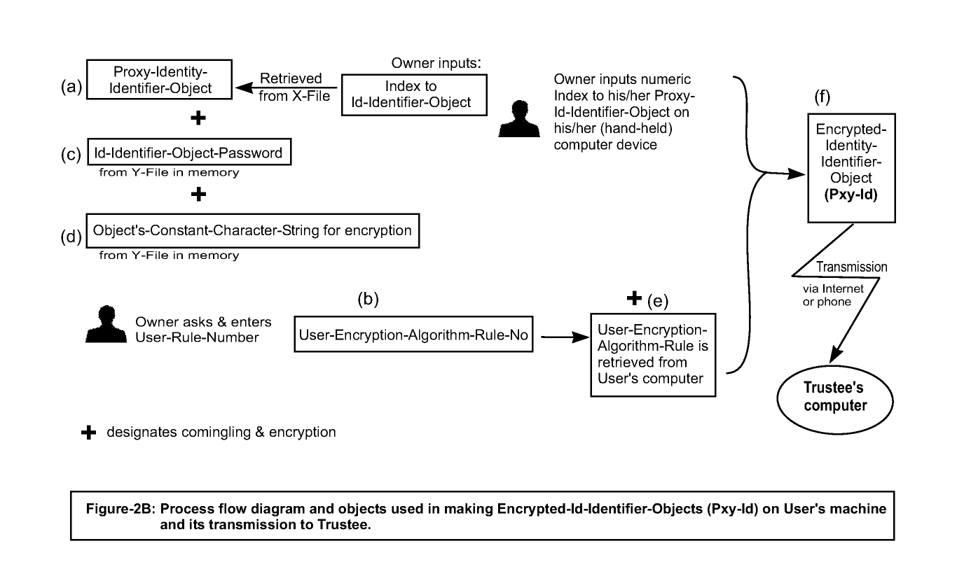

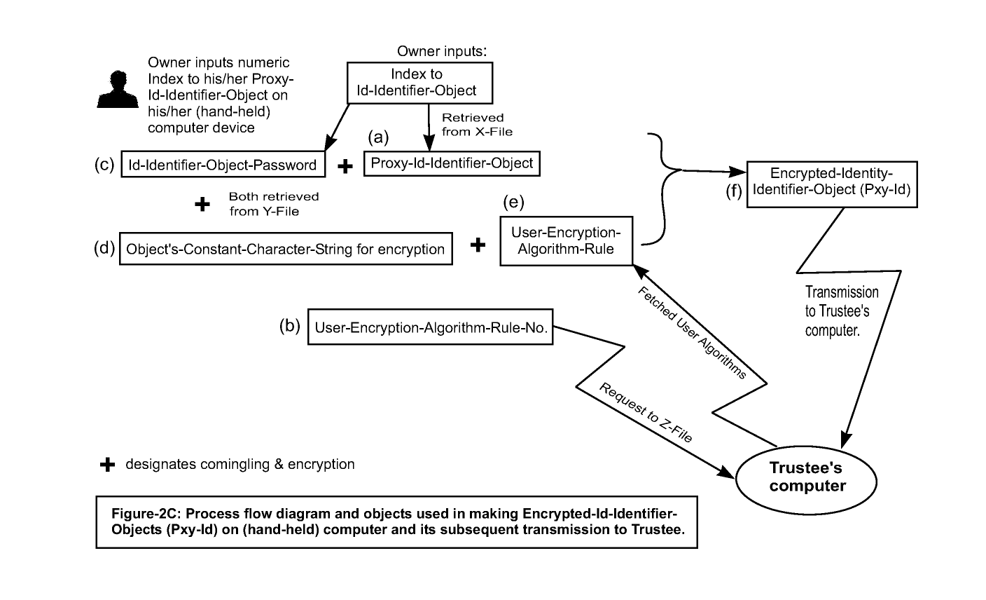

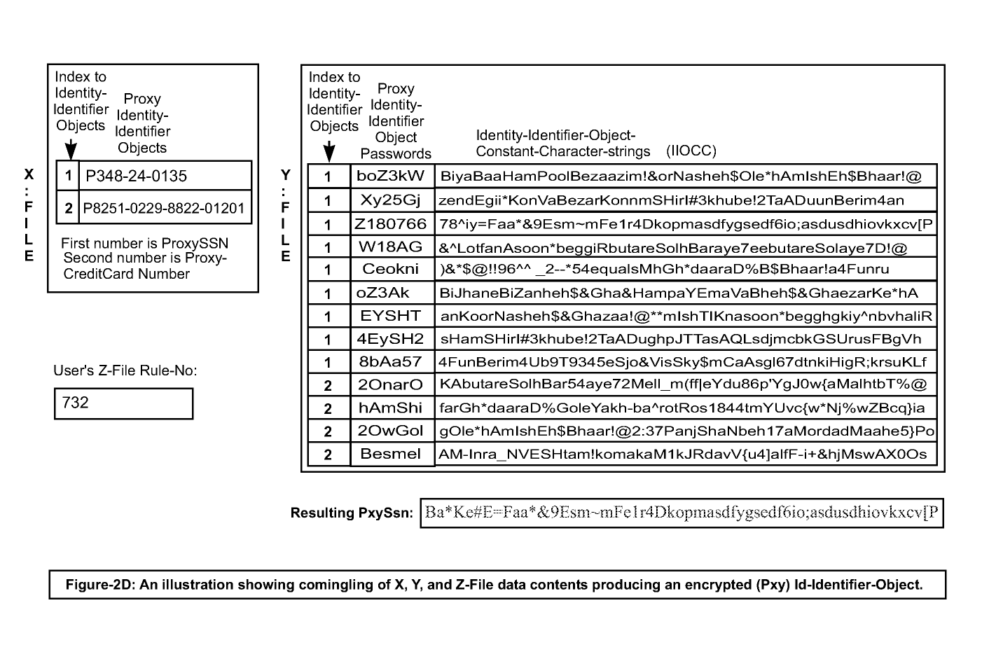

In step 5, the Owner uses his/her own X-File and Y-File data sets along with the custom made User-Specific “User-Encryption-Algorithm-Rule” out of User's Z-File and generates a User-Specific Encrypted-Identity-Identifier-Object (Pxy-Id) for passing on to the Trustee for further processing. See FIG. 2A. In another embodiment of the invention, a procedure as depicted in FIG. 3C, is used allowing for simpler encryption to encrypt lesser secure Pxy-Ids where only one Id-Identifier-Object is to be decrypted by using the value of the Rule-No., itself. This technique is useful where storage space for the recording of X &Y file components is limited, and when cards are used. An example would be Charge Card application. Despite having a simpler method of doing things, for added security, the techniques of FIG. 2A, FIG. 2B, and FIG. 2C are preferred.

The Owner generates a Pxy-Id in either of 3 ways; either entirely on User's computer equipment and peripherals (i.e.: card readers and/or card scanners), on his/her own hand-held computer (phone) device, or by using both of his/her own device and some of User's peripherals and/or processors. We will discuss each of the scenarios, below:
a) The process depicted in FIG. 2B is used in occasions where the Owner is present at User site, having physical access, or communication means to retrieve User-Encryption-Algorithm-Rule by inputting user's specific User-Rule-Number on User's computer and/or computer peripheral. Under this scenario, Owner data elements (a), (c), and (d) of X and Y files originate from Owner's removable/plug-in memory and/or his/her (hand-held) computer device, when the Z-File User-Encryption-Algorithm-Rule is supplied out of User's computer system when the Owner, or User's employee inputs User's assigned Rule-No. into the processing computer's peripheral. See FIG. 2B. For security reasons, the Owner should never hand out his/her plug-in memory module that contains his/her confidential X & Y-Files contents to User's employees, or any other person for that matter.
b) The process depicted in FIG. 2C is used when Owner generates an encrypted Pxy-Id by using his/her own hand-held or personal computer device either totally or partially; and does not have access to Users' computer. These scenarios are handled under procedure flow diagram of FIG. 2C, in which case either or both of the following scenarios are relevant:
   i. The Owner is not physically present on User's site, does not have physical access to enter the User-Rule-No. on his/her machine, and/or is being authenticated long-distance through the phone and/or through other devices such as the Owner's personal or work digital equipment;
   ii. For security purposes, the Owner would prefer to keep his/her Proxy-Identity-Identifiers safe and intact on his/her own hand-held device, removable memory or computer. Owner may want to entirely avoid any physical connection of his/her device to User's computer equipment in order to entirely eliminate the possibility of exposure to spyware, malware, and viruses present in User's machine and the possible transfer to his/her device.
In all of the scenarios as depicted by FIG. 2C, the required X and Y file (Owner) data file contents come from Owner's hand-held device or through the removable/flash memory plugged in the user's personal computer or work computer/equipment. In the latter case, Owner's own processor CPU is used in the process of Pxy-Id generation. While the Owner data elements (a), (c), and (d) of FIG. 2C come from Owner's hand-held and/or Owner's removable memory, the data element (e) is fetched through remote means out of User's Z-file by Owner poking the User's Z-File and supplying the dedicated User-Rule-No. (data element (e)) to the encryption data mix. In the scenario of FIG. 2C, the User's Z-File that is physically located on Trustee's data base, is used. The reason is that the Owner does not have access and/or access rights to User's machine and its data base contents, but can access the User's Z-File on trustees data base through his/her Owner-Account login credentials. By using any of the mentioned methods, step 5 in FIGS. 1 and 1A are completed and the Owner is able to comingle, jumble, and encrypt all of the needed 4 data field elements of (a), (c), (d), and (e) together (see FIG. 2C) and to generate a User-specific instance of “Encrypted-Identity-Identifier-Object” (Pxy-Id); item labeled (f).

By using a programmatic procedure similar to that of FIG. 2D depiction, a unique instance of Pxy-Id can be generated.

In one embodiment the resulting Pxy-Id is transmitted to Trustee for further processing. Refer to step 6 in FIG. 1 while in another embodiment of the invention for charge card processing the resulting Pxy-Id is transferred to Trustee through merchant (User) as shown in FIG. 1A.

In yet another embodiment of the invention, the entire operation of FIG. 2C, as explained in this section is performed entirely on Trustee's computer system by following procedures as outlined in section K of this document.

In step 6, the User custom-made instance of Owner's Encrypted-Identity-Identifier-Object or data components thereof, are transmitted to Trustee, under Trustee-provided encrypting software control. See Event Level 6 in FIG. 1. See also FIG. 2A, FIG. 2B, and FIG. 2C. In charge card processing application, as depicted in FIG. 1A, the resulting Pxy-Id is transferred to trustee via merchant (User).

In step 7 of FIG. 1 per FIG. 4A, Trustee receives the Owner's Encrypted-Identity-Identifier-Object (f) and decrypts it to its comprising components. Also see FIG. 4B for simpler decryption cases such as Pxy-Charge-Card-Number processing. The process in FIG. 4B is the reverse of the process in FIG. 3C.
1) As depicted In FIG. 4A, Pxy-Id (f) is decrypted and extracted into its comprising data components out of which data item (c), being Owner's Identity-Object-Password and User-Encryption-Algorithm-Rule string (e) are of main interest for further processing. Recall that Trustee has a stored copy of Owners X-File and Y-File in its Owner-Account-data base (db1). Since Trustee has other stored Owner information in Owner-Account-data base as well, by performing a table look-up of Owner's Y-File with Identity-Object-Password, the Trustee is able to retrieve Owner's Real/Original Id-identifier-Object and to pass it to Credit Bureau coupled with Owner's other information and User information as retrieved in section 2, below.
2) Trustee has also in store a copy of user's Z-File in its User-Account data base (db2). Therefore, by performing a table look-up with the value of User-Encryption-Algorithm-Rule that had been extracted out of User's Z-File earlier, Trustee is able to arrive at User/Merchant Number, User's name, email address, and other necessary information. This along with the retrieved Owner information in section 1, above, is passed on to the Credit Bureau the User works with. See FIG. 4A. Similar operations are also possible in cases where decryption operations are performed in accordance with the less elaborate methods as depicted in FIG. 4B, where the Rule-No. had been used “by value” for encryption per FIG. 3C.

At the conclusion of step 7, in step 8 of FIG. 1, the Trustee is able to pass on User's Merchant-Number and name along with Owner's real/original Identity-Identifier-Object to the Credit Bureau User works with. Having predisposed information on both the Owner as well as the User (merchant) out of its data bases, the Credit Bureau is now able to pass User's client information to the User (merchant) as it has done in years before this invention.

In another embodiment, for charge card processing, in step 8 of FIG. 1A, the Charge Processing entity receives Owner's true (original) Charge Card Number out of Trustee in step 7; processes the charge against Owner's Charge Card Account, and transmits the said transaction result to the merchant (User).

### H. Departures in Y-File and Z-File Data Field Contents

In a different embodiment, the Identity-Identifier-Constant-Character strings are replaced by a device's internal identification or device codes. Such codes that have been hard-coded on a non-volatile memory in devices' hardware, or by device's software, are read by Trustee's software and fed into the encryption stream when needed. Examples are SIM code of a cell-phone, SID of a Windows computer, MAC address of a network card in a device that is attached to the Internet, and/or a computer's static IP address, DNS Name of a computer server, serial number of a gas pump, a cash register machine's Id and like strings that are either hardcoded in machines' firmware, and available through device's software. Depending on the application and devices in use, one or more of said codes can be used to function in lieu of Identity-Identifier-Constant-Character strings of the Y-File. For some applications, said strings are available in octal, hexadecimal, decimal, character, or binary code that can also be put to use as a different data field of User's Z-File. In this embodiment, the code is used as replacement for either of User-Rule-Number or “User-Encryption-Algorithm-Rule”, and said character constants are used either by “value”, or by “reference”; when used as reference, it serves as location address pointers to parts or all of an Encryption-Rule-Algorithm.

### I. Additional Design Considerations

Each registered Identifier-Object shall receive its own Identifier-Object processing data elements. Said data elements are fields in X-File, and Y-File as depicted in FIG. 3A of this document.

For each and every registered Identity-Identifier-Object, Trustee issues at least one of the following data items in Owner's data set for further processing. Processing is done according to methods and process outlined in this document. Owner-data set comprises:
a. At least one Proxy-Identity-Identifier-Object for every registered Identity-Identifier-Object. Any and all of said Proxy-Identity-Identifier-Objects point to and reference the same original (raw) Identity-Identifier-Object an owner specified in his/her identity and ownership proofs when registering said Identity-Identifier-Object with Trustee. When more than one Identifier-Object is present, a numeric index data field is used, both for ease of reference and linkage to other elements in Owner-data set as enumerated in sections (b) and (c) below. See FIG. 3A.
b. Multiple Proxy-Identity-Identifier-Object-Passwords (Id-Object-Passwords) for each of the Proxy-Id-Objects. Said passwords are linked with common index values to its parent Proxy-Id-Identifier-Objects.
c. Multiple Identity-Identifier-Object-Constant-Character-Strings (Constant-Characters) for each of the Proxy-Id-Objects. Said Constant Characters are also issued by Trustee and are linked to its parent Proxy-Identifier-Objects through the same common index values. See FIG. 2D for sample usage.
d. Trustee assigns a User-Rule-Number (Rule-No.) to each of its User-Account holders; each Rule-Number is linked to a User or Merchant-No., and is also linked to another string of characters, named User-Encryption-Algorithm-Rule string (Encryption-Rule, or “Rule”, for short). A character string and/or substring of this data field may be used by reference address or by value, designating User-Specific-Encryption algorithms that are used in generating instances of encrypted Pxy-Ids. Please see section J, for details.
e. Owner-data set comprising X-File and Y-File data fields together with Trustee generated processing programs are stored in Owner-member-file, and is stored in Owner (plug-in) device memory.
f. User-Number or Merchant-No. (User/Merchant Number) is a number or an alphanumeric string for referencing and locating detail information on its related User entity through search and data lookup operations. See FIG. 3B.
g. In representative Figures-2A, 2B, and 2C, data fields (a), (c), and (d) are Owner data fields of X-File and Y-File; see also FIG. 3A. Data fields (b), and (e) hold User-specific data set (Z-File). See FIG. 3B. User-Rule-No. (b), User-Encryption-Algorithm-Rule strings (e), and User or Merchant Number field, are data fields within every custom made Z-File for Trustee's each and every registered User. Said data collection is also referred to as User-data set (see FIG. 3B), and is stored in what is called User-member-file at Trustee's data base.

### J. Description of User Encryption Rule Number

Trustee assigns a User-Encryption-Rule-Number (Rule-No.) to each of its User-account holders. User Rule-Nos. are not really numbers; rather, they comprise of alphanumeric type characters, but are loosely referred to as numbers. It is possible to use a Rule No. string in two ways; a) as a value, and b) as a reference (called pointers, in software design). When used as a “value” one or more of its comprising individual characters are concatenated and comingled into bunch of other characters originating from characters within data strings of Owner-data sets. See FIGS. 2A through 2D. For example, in figure-2A, a Rule No. in the (b) field causes the retrieval of data field (e) out of User's Z-File, which is comingled with strings originating from one or more of X-File's (a), (c), and (d) data fields. In FIG. 3C, for a simpler operation, one data element from X-File and one or more data element from Y-File are comingled and encrypted with User's Rule of Z-File. The + sign in these diagrams indicate such an operation. When a Rule-No. is used as a reference pointer to an address, each or all of its comprising characters would be used to reference and call individual characters or character substrings of a much longer string containing more diversified characters of extended UTF and extended ASCII characters (User-Encryption-Algorithm-Rule) into the comingling and concatenating action. Each character or substrings of said character strings can, in turn, point to specific code snippets that perform a certain comingling and/or jumbling operation.

By using said design guidelines, creative programmers are able to create thousands of concatenating, comingling, jumbling, and encrypting code snippets and character manipulation routines, especially by mixing the two mentioned models of “by value” and “by reference” in combination.

In this invention we assign one specific Rule-Number to each of registered Users along with its own proprietary character manipulation and encryption technique (Rule). As we observe in the Z-File design, each Rule (User-Encryption-Algorithm-Rule) has its own associated character string data elements, allowing large flexibility in the design and creation of User-specific Rules to be assigned for thousands of Users and User-Groups existing in the real world. Observing FIGS. 2A, 2B, and 2C, said User(Specific)-Encryption-Algorithm-Rules (e) are applied to a collection of Owner data contents of X-File and Y-File data fields (a), (c), and (d), along with Z-File data elements of (b), and (e) to produce a resulting User-specific instances of Encrypted-Identity-Identifier-Object, (f) (Pxy-Id). Finally, as noted before, the User-No. or Merchant-No. field of the Z-File indicates which registered User is the end receiver of the encrypted Pxy, and Proxy Id-identifier-Objects. This aspect of the design makes it easy to trace and prosecute a User that has leaked out and spread the confidential Identity-Identifier-Objects of people, businesses, organizations, and other Users.

Trustee is charged with the task of devising many different encryption algorithms such that each algorithm is dedicated to a specific User business, organization, and agency, or collective groups of such entities who conduct and partake in the same business or business activity. One such example is a bank acting as a depositor's account holder and also as a loan extending institution.

The design of all Rules, its associated algorithms', code, and the value of Rule Numbers and Rules should be considered and treated as “business secret” by all participants. All code and clues to algorithm architecture and design must remain secret, and should be considered the designing Trustee's “confidential property”, as any clue to its design will provide a strong lead in breaking the design of one or more other algorithms. Designers, programmers, computer support personnel, network engineers, system administrators, and network security personnel should all sign confidentiality agreements with Trustee and treat all of their work under “strict security regulations”.

Whereas any public give-away of one or more algorithms shall result in reducing the available variety in class, and ultimately in number of available algorithms, any full exposure to code of such an algorithm, other than in the disclosure in FIG. 2D is not possible to be included as part of this document.

### K. Over the Phone and Long Distance Identity Authentication

When a User would require a credit and/or background check on its customer (Owner), the User would inform the customer of such an intention over the phone, via email, via text message, and so on. The Owner would then ask for User's User/Merchant-No. and transmits it to Trustee along with his/her login-name, coupled with a valid password. The Trustee retrieves the Owner-data set, also retrieves the associated User Rule out of User's Z-File, then combines said Owner and User data sets and generates an Encrypted-Identity-Identifier (Pxy-Id) on its computer. Trustee then uses the needed Owner and User identifying data out of its account-data bases and transmits it to Credit Bureau as depicted in FIG. 4A. See also FIG. 1, step 7; and FIG. 1A, step 7 for Charge Processing applications, in which trustee sends the retrieved charge account numbers and name to Charge Processing entity.

In another embodiment, when the processing power and the storage capacity of Owner's computer permit, the Owner would ask for User's User/Merchant-No. and generates a User/Merchant specific-Encrypted-Identity-Identifier (Pxy-Id) on his/her hand-held device, personal, or work computer, as depicted in the procedure of FIG. 2C. At the conclusion of this procedure, most of which happens automatically through Trustee-provided Apps/programs (per section F), the Owner generated Pxy-Identifier is transmitted to the Trustee's computer.

After receiving the Pxy-identifier, the Trustee decrypts the received information and sends it to a Credit Bureau Event Label 7 in FIG. 1, serving the User's account, or to requesting User/Merchant while processing a charge card per FIG. 1A, Event Label 7, depending on the nature and type of the remote request. See also FIGS. 4A, and 4B.

### L. Charge Card Numbers as Identity-Identifier-Objects

FIG. 1A outlines consideration and treatment of a charge card number as an Identity-Identifier-Object. Although people are not used to treating a charge card as an identity identifier to authenticate their identity with; nevertheless it can be done when registered through a Trustee and the methods outlined in this document are applied. Despite this, we are going to apply methods of this invention to charge cards with a different objective; that is to protect the charge account owner from unauthorized use of a charge number, without his/her knowledge and consent.

Processing a credit card and charge number as depicted in FIG. 1A is very similar to processing any other Identity-Identifier-Object as already outlined in FIG. 1, only with two deviations. The first is in step 5. For credit cards, and when customer is present, the Encrypted-Charge-Card-Number (its Pxy instance) is generated on a credit card machine on merchant's end, instead of Trustee's end. This is desirable, rather than necessary, because the customer wants the charge paper-receipt, and the merchant would also need a proof of sale on its own end until he/she gets paid by the charge processing company, and in many cases for its point of sale accounting and inventory tracking purposes. The deviation introduces a diminished security aspect of the application, because at least theoretically a merchant can use the same Pxy card number again for a bogus sale. This risk has minor implications, since a bogus charge can always be traced back to the merchant, and such charges will be considered as “charge-backs” and are reversible through merchant account contracts with all of card processor companies and banks. The second difference between the procedures outlined in FIG. 1A with FIG. 1 is the replacement of Credit Bureau entity with charge processing company or a bank. Other than these, and the names of data items that are being passed, there are no basic structural differences between the two procedures.

Please refer to the outlined procedure in section K, above, for Charge Card purchases when customer is not present.

### M. Access Codes as Identity-Identifier-Objects

In addition to charge card numbers, consideration and treatment of Access Codes as Identity-Identifier-Objects is another example of applying this invention's methods and procedure to “Semi-Fixed-Id-Identifier-Objects”.

Like processing other forms of Identity-Identifier-Objects, a similar procedure as depicted in FIG. 1 is used for this kind of application, as well. Again, two minor departures are notable. In step 5, in lieu of merchant/User entity, an encrypted/Pxy instance of the master access code is entered/scanned into a reader of sorts. In step 6, the code is passed to a processing machine acting as Trustee for decryption and validation; in effect the processing computer and scanner/data entry peripheral are functioning as a Trustee in breaking up the returned Pxy-Id into its original, unique Master Access code and its Permission Component, utilizing Y-File Constant Character Strings to function as rights and permissions flags. The unscrambled results are then passed to a computer data base, in lieu of a Credit Bureau; Said computer data base has the permission credentials and matches those data items entered versus those on its data bases. If the match is successful then it validates access and sends an electronic signal to the door opening relay mechanism, or permissions to access the resource. It is also entirely possible to let said Trustee computer to totally take over and to also automatically issue, re-issue, cancel, and update all access codes, its attached rights and extent of use permissions that are granted to each code.

### N. Considerations on Digital Signatures

Conversion of peoples' signatures to digital form that are stored in binary files is an everyday common activity at least every time we sign for a purchase on a credit or debit card. Currently there are three problems with digital signatures:
1. Recognition and comparison of digital signatures is problematic for a computer, unless a very sophisticated software is used, and even so, the software's error margin should be acceptable to Users based on a standard acceptability criteria. A universal acceptability standard does not exist, and none has been set so far.
2. A second big problem with digitized signature files/strings is the fact that even without the Internet, binary digital signature files and strings can easily be transferred from machine to machine, saved, accessed, copied, and distributed in seconds; hence, easily stolen, and misused. For example, in most point-of-sale electronic cash registers in retail stores, or every time we receive a delivered package. Such digital signatures are stored as strings or binary files. They can be copied out of the cash-register/credit card signature pads, or signature pads of delivery services; be hijacked, replicated and inserted at the bottom of documents a person is not aware of, and he/she never had intended to sign.
3. Currently there is no way to authenticate that a seemingly valid electronic signature, has in actuality been signed by its owner. In other words, for electronic signatures, “signature witnessing” is lacking.

The US Government has approved use of digitized signatures with certain non-guarantee-able stipulations which are of weak bindings or are based on hard-to-prove legal foundation. Securing signatures with commonly used “Public-Private-Key” encryption techniques only provide a safer way of delivery and receipt of signed names and digital signature files. This kind of technique that is widespread and in use by most application software, lack the one basic and very important aspect (property). Public-Private-Key encryption technique cannot be used to authenticate “who signed the document”. It can only authenticate the source computer or the person who sent it; a fine but neglected point. By producing and sending digitized signatures utilizing the outlined methods of this invention, we are able to use the signature file to authenticate its Owner; meaning the person who signed; in other words, electronic signature notarization is achieved. Even though Public-Private-Key encryption methods guarantee a rather safe delivery of digital signature files when used within SSL Transport Protocol Layer, such methods are only as good as having received a signature on paper without having had a Notary Public or a witness present to authenticate the person who actually signed the document. With this invention, using encrypted proxy (Pxy) signatures, and having placed a Trustee in the information flow path the “Notary Public Issue” has been resolved. Another, but solvable problem exist with Public-Private-Key encryption methods. Currently, the Private Encryption Keys that are assigned to organizations can be misused by work-place employees. For example, if at our work-place my co-worker Joe copied my digital signature and placed it under a document I never intended to sign, and used our work place's Encryption Private-Key, I would have a hard time proving that it was not me who signed the document and sent it. This problem can be solved if a company would be willing to invest in obtaining a Private-Encryption-Key for every one of its employees and for all of the computer workstations. However, with this invention, once a registered signature Owner has registered an instance of his/her digitized signature, the signature can be authenticated back to him/her and his/her identity can be authenticated using a Pxy code reference registered to the signature, no matter where, or on which machine. This is the proposed model for the future. Also see related material in section O, below.

### O. Binary Files as Identity-Identifier-Objects

Digitized forms of signatures, fingerprints, photographs, and the like, when stored as binary data files can similarly be registered through a Trustee as Identity-Identifier-Objects and be processed under the same methods and procedure as outlined in this document.

Music, video production, software, digital arts, digital work, and other types of digital content that are sold or licensed to the public in electronic files, can also be registered and treated as Identity-Identifier-Objects with a Trustee, in the context of this invention and though use of methods and procedures as outlined in this document. In doing so, an optional departure is available. The software producer, reseller, distributer, or a cloud-computing software provider—and when software is made available through an Application Server based on use, the software license distributer can act in the capacity of a Trustee to manage and enforce ownership, licensing, permissions, and usage rights of the software and other digital content production. By using this invention, makers, distributers, and cloud computer servers of software and other digital work of value can effectively and positively manage their own digital content products and licensing by becoming Trustee gate-keepers of their own property, to enforce and ensure proper usage of license provisions; hence maximize their revenue.

### P. Biometric Data Files as Identity-Identifier-Objects

Applying methods and procedure that has been specified for other digital and binary files in this document, would be no different, when any biometric signature is translated to a digital file along with its Owner information, and is registered just like other Identity-Identifier-Objects to its Owner. The only consideration to be mentioned in this regard is that the same person Owner may have to register with Trustee, many DNA, and other unique biological features and signatures, each as an individual Id-Identifier-Object, granted that not all of stored information may be used at any one time. Therefore such unique biological features and signatures might have to be categorized with additional indexed attribute data fields in X and Y-Files, and augmented with “reliability” and/or “usability” indicator flags per stored data segment that are embeded in the Y-File Constant-Character-Strings. See FIG. 3A.

### Q. Detailed Registration Process by Trustee

A person interested in gaining controlling exposure of his/her Identity-Identifier-Objects applies to a Trustee organization and applies to open one or more account types. There are two account types available: Owner-Account, and User-Account. Owner-Account is for registering one or more Identity-Identifier-Objects that belong to a person or organizations of types (Users). User-Accounts are for Users of Identity-Identifier-Objects to be able to benefit from aspects of being owners of virtual and physical Identity-Identifier-Objects (see Section E). It is clear that a User organization may also need to have Owner-Account of its own if it needs to protect its property, usage, access, and/or any licensing rights that are attached to such property objects.

In actuality Trustee will decide on, and set the exact procedures that should be required to open Owner and User accounts. However, we would go over some basics here in this section.

The application and registration process may be accomplished either through the internet, via the conventional mail, or in combination.
a. Owner-Account registration may be done through a secure web site link or other secure interfaces that the Trustee has setup and maintains. An applicant may go to the Trustee's web site and apply in person, or he/she may go to a Notary Public, or other Trustee designated local agents, and agencies. Under all scenarios, a membership application form must be completed as specified by Trustee, in which the applicant must read and agree to some legally binding documents and “Terms and Conditions of Use”, and provide more than one official/government pictured ID documents for Trustee to make sure of the applicant's true identity. If and when the applicant is applying over a web connection, a signed “Affidavit of Personal Identity” form must also be prepared and witnessed by a Notary Public or an attorney. A hard copy of all signed documents along with photocopies of pictured personal ID documents must be sent to Trustee's business address via secure mail. In addition to the above, the applicant must provide valid purchase and other documents proving his/her ownership to the object he/she is registering. Such document must contain the object's tag, serial number, and/or installation keys and information pertaining to object's access, usage rights and permissions, if any.
b. In registering a User-Account, the business owner, and/or one or more corporate registered agents act as an Applicant and would carry out the required procedures for registration; very similar to those mentioned above, for Owner-Accounts. Not only an organization's registering agent should present his/her official ID cards for personal authentication, the registering agent must in addition, supply incorporation and/or organization' charter documents. For any organization owned property and objects to be registered with the Trustee, Owner-Accounts are to be opened, in addition to at least one User-Account, and applicable ownership documents must also be presented.

The foregoing description and accompanying drawings illustrate the principles, preferred embodiments and modes of operation of the invention. However, the invention should not be construed as being limited to the particular embodiments discussed herein. Additional variations of the embodiments discussed above will be intuitive by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

### R. Detail Description of Drawings

Drawings' Legend: Ellipses show the entities, rectangles represent data-items, small circles with number inside show sequence of steps in the procedure, called Event Labels or steps. Arrows show the flow of information and data items. The diamond shape indicates a condition to be satisfied (pending authentication), and braces show grouping of data items in the flow of data and the information.

FIG. 1: “Overall process flow of Proxy and Pxy Identity-Identity-Identifier-Objects to shield the Real Identity-Identifier-Object”. The diagram shows the entire basic process and relationship of objects and entities that are used. Depending on the type of Identity-Identity-Identifier-Object we are processing, minor variations in this general diagram are expected.

Event Label 1: Owner applies for Pxy-Id account from Trustee. See Section C-1 for more.
Event Label 2: Trustee verifies the identity of the Owner and ownership documents. See Section C-2 for more. Upon positive verifications of step 2, above, Trustee issues login name and password for the Owner, and stores the information in “owner-member-file”. Trustee also issues Owner X and Y Files comprising proxy-identifiers, identifier-passwords, and identifier-character-strings.
Event Label 3: Trustee stores all Owner data in “owner-data set”, as well as storing links to owner-data set information in owner-member-file and “owner-account-data base”.
Event Label 4: Issued Owner X and Y Files are stored in one of a plug-in memory or device memory and is securely shipped to the Owner.
Event Label 5: Owner plugs in his/her plug in memory into an encrypting processing computer or (mobile) device, or alternately into User's computer peripheral; obtains and inputs the User-Rule-Number and generates an encrypted (Pxy) Identifier per FIGS. 2A through 2D.
Event Label 6: The generated Pxy-Identifier is transmitted to Trustee. Trustee decrypts the encrypted data item and extracts the Proxy Identity-Identifier-Object and Proxy-Identity-Identifier-Object-Password out of it.
Event Label 7: By using its owner-account-data base, Trustee retrieves Owner's original (real) id-identifier-object. Also by using its “user-account-data base”, Trustee extracts User/merchant information and sends it to a Credit Bureau which the User works with. See FIG. 4A.
Event Label 8: By using Owner's real identity-identifier and User/merchant number and information, the Credit Bureau is able to send User's requested information to the User/merchant.

FIG. 1A: “Charging a purchase with Pxy Charge Card Numbers that change with every merchant”. The type of Identity-Identifier-Object in this flow diagram is a Credit or Debit Card number. Trustee issues the equivalent Proxy Charge Card Numbers and the methods described make it possible for the merchant to work with an encrypted instance of the number that is named Pxy Charge Card Numbers that change with every merchant. In this process flow diagram a charge processing entity functions in place of the Credit Bureau entity of the FIG. 1.

Event Label 1: Owner applies for Pxy-Charge-Card account from Trustee.
Event Label 2: Trustee verifies the identity of the Owner and the charge account ownership and documents. After positive verifications, Trustee issues login name and password for the Owner, and stores the information in “owner-member-file”.
Event Label 3: Trustee issues Owner X and Y Files comprising proxy-charge-card-numbers, identifier-passwords, and identifier-character-strings and stores the data in “owner-data set”, as well as storing links to owner-data set information in owner-member-file and “owner-account-data base”.
Event Label 4: Issued Owner X and Y Files are stored in one of a plug-in memory, device memory. Alternatively, only one Proxy-Identifier (Charge-Card-No.) and its associated passwords are recorded on an optical, magnetic, or smart card. Said recorded X and Y File data are securely shipped to the Owner.
Event Label 5: Where applicable, the Owner plugs in his/her plug in memory into an encrypting processing computer or (mobile) device, or alternately scans the magnetic or optical card into User's charge machine/peripheral; obtains and inputs the User-Rule-Number and generates an encrypted (Pxy) Identifier per FIGS. 2A through 2D, or FIG. 3-C in case of a simpler implementation. The generated Pxy-Identifier is delivered to the merchant/User upon purchase/charging.
Event Label 6: At the time of purchase, the generated Pxy-Charge-Card-No. is delivered to the merchant, and also is transmitted to Trustee.
Event Label 7: Trustee extracts Owner's original (real) charge-card-number by using its owner-account-data base. Also, by using its “user-account-data base”, Trustee extracts User/merchant information and sends it to a Charge-Processor entity which the merchant works with. See FIG. 4A. Also see FIG. 4-B for cases of simpler implementation.
Event Label 8: By using Owner's real identity-identifier and merchant's number and information, the Charge-Processor entity is enabled to send the credit or debit request to merchant's bank account, along with a confirmation to the merchant.

FIG. 2A: “Basic understanding of objects necessary to make Encrypted-Id-Identifier-Objects”. This is a schematic showing the 4 data elements (a), (c), (d), and (e) that combine and jumble together. The 4^{th} data element (e) is a value of an Encryption-Algorithm-Rule that is designed differently for every User of an Id-Identifier-Object. Numerous modes of generating an Encrypted-Id-Identifier-Object (Pxy-Id) are possible, depending on the location and equipment on which Pxy-Id is generated. FIG. 2-A is the overall, conceptual diagram.

FIG. 2B: “Process flow diagram and objects used in making Encrypted-Id-Identifier-Objects (Pxy-Id) on User's machine and its transmission to Trustee”. This procedure is usually used when an Owner is present at User's site, and is able to retrieve User-Encryption-Algorithm-Rules out of User's computer terminal and can perform bulk of the encryption process on the User's CPU. Data elements (a), (c), and (d) come from Owner's hand-held device and/or (plug-in) memory while data element (e) comes from User's machine, after Owner optionally asks for and enters data element (b) into his/her device.

FIG. 2C: “Process flow diagram and objects used in making Encrypted-Id-Identifier-Objects (Pxy-Id) on (hand-held) computer and its transmission to Trustee”. This schematic diagram shows how Encrypted-Id-Identifier-Objects (Pxy-Id) are generated on Owner's hand-held computer or on a home PC. This method is used in long-distance and over-the-phone Id authentication and when Owner is not present at User's site or does not have access to User's computer peripheral/station. Note that in this configuration, data element (e) comes from Trustee's machine after Owner log-in is authenticated by Trustee's computer, and after Owner transmits at least one of data elements (a), (c), (d), and (b) to Trustee's computer.

FIG. 2D: “An illustration showing comingling of X, Y, and Z File contents producing an encrypted (Pxy) Id-Identifier-Object”. Following is just an illustrative example of thousands of programmatic code variations that are possible:

1. Owner enters index of 1 and selects his/her ProxySsn of: P348-24-0135
2. Owner enters 732 for User's Rule-Number from which the long Rule-String is retrieved. See FIG. 3B.
3. Owner enters his/her password. Access is granted, when matches any of second column Y-File passwords.
4. Rule-No. 732 says: take the password to match the first digit of ProxySSN, which is the 3rd password of the Y-File. That is: Z180766. Since Z is the last letter of the alphabet, then go to the last position of the Rule-String of the User Z-File.18 is the next 2 digits of the password, meaning take 18 characters from end, go to the left, and cut characters for the length of 07 (which is the next 2 digits of the password), and attach the resulting sub-string before the 6th position of the IIOCC string in the Y-File. Rule 732 only operates on the first 6 characters of the Proxy-Id-Passwords; therefore the comingling, and encryption operation is now complete.
The resultant PxySSN is:

Ba*Ke E=Faa*&9Esm˜mFe1r4Dkopmasdfygsedf6io;asdusdhiovkxcv[P

FIG. 3A: “Representative diagram showing X-File &Y-File data fields and structure”. These files reside in removable memory module for plug in into the computer that generates Encrypted (Pxy) Id-Identifier-Objects, or are built in the device that is distributed by Trustee. The title of this diagram explains what the diagram is. Data fields in X and Y Files are also referred to as “owner-data set”, and are used in the manufacturing of Encrypted-Id-Identifier-Objects, by adding in and comingling User's Z-File data fields.

FIG. 3B: “Representative diagram showing Z-File structure and data fields. This file resides in User computer & at Trustee's data base.” Rule data out of this file is also used to generate Encrypted (Pxy) Id-Identifier-Objects”. Where X-File and Y-file supply Proxy Id-Identifier-Objects, Proxy Id-Identifier-Object-Passwords, and Id-Identifier-Object-Constant-Character-Strings, Z-File supplies User-Rule-Number and User-Encryption-Algorithm-Rule code in a character string that designate the encryption algorithm(s) to be used by value or by its address references.

FIG. 3C: “View of a simpler process to form Encrypted-Identifier-Objects (Pxy-Id) by using one of Owner's Identity-Identifier-Objects with Rule-No.”. This diagram is a simplified combination of the data elements of Figures-3A, and 3B. This procedure is used for when simplicity of a process outweighs its increased security risks. The process would be used for when we are dealing with only one Id-Identity-Identifier-Object and limited number of identity-passwords that must be recorded on magnetic or optical cards with less storage and limited possessing options.

FIG. 4A: “Trustee's decryption of received Encrypted-Id-Identifier-Object into its comprising objects with subsequent retrieval and transmission of data items (h), (i), (j), and (k) to Credit Bureau or Charge Processor, as applicable. This allows Trustee to search its data bases and eventually retrieve Owner Real Id-Identifier-Object and the User/Merchant-No. Said two numbers are passed on to Credit Bureau for the look-up and retrieval of requesting Owner information to User. Following is a detail explanation of the procedure:

Trustee receives an Encrypted-Id-Identifier-Object (Pxy-Id) (f), uses its decryption engine and decrypts the encrypted (Pxy) Id-Identifier-Object into its components, namely, Id-Identifier-Object, Id-Identifier-Object-Password, and User/merchant Encryption-Algorithm-Rule strings. Trustee then uses its owner-account-data base (db1) to retrieve Owner-Identifier-Object along with Owner-Name; Trustee also uses its user-account-data base (db2) to retrieve Id-Object's User Number and User Name. Trustee then sends said retrieved data to Credit Bureau. Credit Bureau then retrieves detail Owner information and sends it to User whose information was also received from Trustee. Alternatively Trustee can perform the entire step in FIG. 4A, by itself.

FIG. 4B: “Decryption process when encryption process of FIG. 3C had been used”. This diagram shows the reverse process of FIG. 3C, and is to be used in simpler processes, such as processing a credit or a debit card account. The resulting decrypted Id-Identifier-Object (charge card account number) is sent to Credit Bureau or to a charge card processing entity in a process similar to the one shown on FIG. 4A.

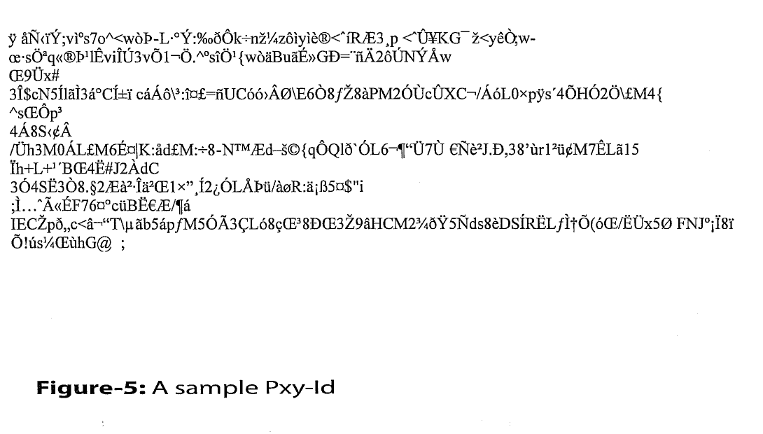

FIG. 5: “A sample Pxy-Id”. This diagram shows a sample representation of an Owner's Encrypted-Id-Identifier-Object, or “Pxy-Id” for short.

What is claimed is:

1. A four way method for authenticating to third parties the ownership of an object, said method implemented on a computer system having processors configured to perform the steps of:
providing a trustee, via a computer system, with personal information, at least two proofs of identity of a person, and said person's proof of ownership of said object, the trustee performing the steps of:
verifying the identity of the person;
upon a positive authentication, enrolling said person as the object's owner in trustee's computer system by issuing one access password;
issuing an owner-data set comprising at least one proxy-identifier, and at least one identity-identifier-password along with at least one identity-identifier-character-string, all associated with at least one proxy-identity-identifier of the said owner;
creating encryption program code and procedure;
creating an owner-member-file comprising said program code and owner-data set;
saving said owner registration information along with a copy of owner-member-file in owner-account-data base;
storing said owner-member-file in at least one of a plug-in memory or a portable electronic device;
delivering said owner-member-file to said owner through secure means;
accepting and enrolling third party business organization users and user-groups of identity-identifier-objects as third party user members;
providing said business organization users and user-groups with computer login information and password, and storing said information in user-account-data base;
for each user-member programming a dedicated encryption-algorithm-rule-string, associating said string with a rule-number, and referencing said encryption algorithm-rule-string with at least one rule-number, and a user-number;
assigning one of said rule-string and rule-number to at least one third party user or user-group in the same business;
assigning, associating and storing a rule-number, said rule-string with a third party user-number in user-data set;
saving a copy of user-data set in user-account-data base;
recording said user-data set in built-in memory of a digital peripheral fit for use with third party user computer;
delivering said digital peripheral, and digital contents to said third party user via secure means;
owner generating an encrypted-proxy-identifier by applying third party rule-string to a combination of at least one of owner's proxy-identifier, one of owner identity-identifier-passwords, and one of owner identity-identifier-character-strings;
owner delivering said encrypted-proxy-identifier to trustee;
trustee decrypting the received encrypted-proxy-identifier by applying decrypting algorithms and extracting owner proxy-identity-identifier-object and third party rule-string;
trustee searching owner-account-data base with owner proxy-identity-identifier-object and extracting owner-identity-identifier-object, and transmitting it to credit bureau's computer system;
trustee searching third party user-account-data base with user-rule-string and extracting user-number with third party user information, and transmitting it to credit bureau's computer system;
credit bureau searching its data base and matching transmitted owner-identity-identifier-object against its predisposed owner information on file;
credit bureau declaring the person to be the owner of said object upon positive match;
credit bureau searching its data base and matching transmitted user-number against its predisposed third party user information on file; and
credit bureau granting access to object's pre-disposed information per credit bureau's contract to third party user, excluding object's original identifier.

2. The method of claim 1, further comprising wherein said object is a) a physical or virtual object with a physical or virtual defined boundary, and b) is traceable to its owner through a unique token, alphanumeric tag, or serial number.

3. The method of claim 2, further comprising wherein said object is pre-registered with a trustee, and is authenticated through the trustee using an ownership property.

4. The method of claim 1, further comprising:
requiring the credit bureau to register and enroll with the trustee.

5. The method of claim 1, further comprising:
trustee assigning and issuing one of a different rule, associated rule-number, and user-number for use by one third party user or third-party business associates that are engaged in conducting same, or related business function.

6. The method of claim 1, further comprising wherein said object's identifier being an alphanumeric or digital representation of at least one of fixed-for-life-of-the-object identity identifiers, including at least one of an organization's Employer Identification Number (EIN), Tax Identification Number, a person's social security number, iris pattern, earlobe pattern, DNA structure, biometric information, or other fixed for life unique identifiers.

7. The method of claim 1, further comprising wherein said object's identifier being an alphanumeric or digital representation of a semi fixed personal identifier including at least one of a charge card number, driver's license number, patient number, insurance number, student number, log-on user's name, access code, software license number, a token, a tag, or other semi-fixed identifiers.

8. The method of claim 1, further comprising wherein said object's identifier being an alphanumeric or digital representation of a variable-personal-identifier including at least one of a person's signature, fingerprint, picture or other variable-personal-identifiers.

9. The method of claim 1, further comprising wherein said object's identifier being at least one of a person's or an organization's digital production, software, usage rights, rights of ownership, authority, or privilege of various degrees with said right having been allocated through one of an identifier, access code, a serial-number, an identity-verifier, or an identity-identifier to said object's owner.

10. The method of claim 1, further comprising wherein by entering an access password a person generates an encrypted-proxy-identifier-object by applying a third party-user's pre-allocated encryption rule or set of rules to at least one of a proxy identifiers-objects and one of said object's related passwords.

11. The method of claim 1, further comprising wherein after entering a valid password and a numeric index, a person transfers at least one of object owner's encrypted proxy-identifier-objects to trustee or third party user's computer system or peripheral out of owner's computer, portable device, and/or plug-in memory.

12. The method of claim 1, further comprising wherein after entering a valid password and a numeric index, a person remotely transfers at least one of object owner's encrypted proxy-identifier-objects combined with an identifier-password to trustee or third party's computer system or peripheral out of owner's personal computer or electronic device.

13. The method of claim 1, further comprising wherein by entering a password and a numeric index, a person transfers at least the one of an object owner's encrypted proxy-identifiers combined with an identifier-password to a third party user's computer system or peripheral out of one of an optical device, a smart card, RFID, or other computer and digital devices.

14. The method of claim 1, further comprising wherein by entering at least one password and a proxy-identifier-index, a person retrieves owner-data set and encrypts it with a third party's rule through trustee's computer interface.

15. The method of claim 1, further comprising wherein by transmitting an index to an identifier-object with a password and a third party's user-number, a not physically present person would have trustee transmit one of said person's identifier-objects to a credit bureau.

16. The method of claim 1, further comprising wherein for the purpose of ownership identity authentication, or usage to the extent of preset rights, authorization, and permissions person would have trustee transmit to third party user location, preset values of data set strings indicating an extent of a right or permission to a computer system software having a pre-defined SID, MAC, static IP, other hardware or software addresses within a network.

17. The method of claim 1, further comprising wherein for every trustee-registered identifier-object of an owner, at least one indexed proxy-identifier-object is also issued, such that for each proxy-identifier-object there exists at least one object-identifier-password and one constant-character-string.

18. The method of claim 1, further comprising wherein for every trustee-registered identifier-object of an owner, at least one indexed proxy-identifier-object is also issued, such that for each proxy-identifier-object there exists at least one of object-identifier-password or one constant-character-string.

19. The method of claim 1, further comprising wherein trustee decrypting one of encrypted proxy-identifier-object to its original comprising components through applying reverse algorithm to owner-data set and rule corresponding to rule-number used in encrypting said encrypted proxy-identifier-object.

20. The method of claim 1, further comprising wherein in the absence of trustee entity, a credit bureau functions as both credit bureau and trustee entity, and assumes the additional duties, functions, and role of trustee.

21. The method of claim 1, further comprising wherein in the absence of a credit bureau entity, trustee functions as both credit bureau and trustee entity, and assumes the additional duties, functions, and role of a credit bureau.

22. The method of claim 1, further comprising wherein after login, by transmitting an index to an identifier-object with a password and a third party's user-number, a not physically present person would have trustee transmit one of said person's encrypted-proxy-identifier-objects to a third-party-user.

23. The method of claim 1, further comprising wherein after login, by transmitting one of an identifier-object or its associated index along with a password and a third party's user-number, a not physically present person would have trustee and credit bureau transmit said owner's identity-authentication result along with credit score and/or other retrieved information to said third party user's computer.

24. The method of claim 1, further comprising wherein a charge processing entity is replaced for credit bureau entity in charge card processing operations.

25. The method of claim 1, further comprising wherein an owner-member-file is delivered to owner with no encryption program code included.

26. The method of claim 1, further comprising wherein at least one intelligent computer substituting and functioning as any or all of owner, trustee, credit bureau, and/or user enteritis sending data to other computers, electronic devices and peripherals functioning collectively or separately as owner, user, trustee, and/or credit bureau entities.

27. The method of claim 1, further comprising wherein each of the at least one identity-identifier-constant-strings, and at least one encryption-rule-strings include at least one character out of the extended UTF international character set.

28. The method of claim 1, further comprising wherein each of the at least one of proxy-identity-identifier-object is as small as one byte of data.

29. The method of claim 1, further comprising wherein any and all encrypted or unencrypted substitutions of identifier object is deemed to be a proxy identifier object.

30. The method of claim 1, further comprising wherein said object identifies at least one of a virtual or physical object, a person, a business, or an organization comprising a number of people that officiate or conduct the business of a unit, provided said object had uniquely been registered to its owner through a trustee.

31. The method of claim 1, further comprising wherein an encrypted proxy-identity-identifier-object is used in lieu of a person's notarized signature when said person is the owner of a trustee-registered digital signature that had been registered as an identity-identifier-object.

32. The method of claim 1, further comprising wherein said identity-identifier-object is a digital representation of one of a uniquely identifiable DNA sequence of its owner that had been registered as an identity-identifier-object through a trustee.

33. The method of claim 1, further comprising wherein said identity-identifier-object is a digital representation of an instance of one of a person's fingerprint or a person's photograph that had been registered as an identity-identifier-object through a trustee.
